(19) United States
(12) Patent Application Publication
(10) Pub. No.: US 2006/0146464 A1
(43) Pub. Date: Jul. 6, 2006

(54) Overvoltage protection device

(75) Inventors: Swee Keong Tan, Chanhassen, MN (US); Robert J. Marks, New Hope, MN (US); Jung Chi Yang, Jhonghe City (TW); An Yu Kuo, Sanchong City (TW)

Correspondence Address: FOLEY & LARDNER LLP, 777 EAST WISCONSIN AVENUE, SUITE 3800, MILWAUKEE, WI, 53202-5308, US

(73) Assignee: Fiskars Brands, Inc.

(21) Appl. No.: 11/135,871

(22) Filed: May 24, 2005

Related U.S. Application Data
(60) Provisional application No. 60/641,627, filed on Jan. 4, 2005.

(51) Int. Cl. H02H 3/027

(52) U.S. Cl. 361/91.3

(57) ABSTRACT

An overvoltage protection device includes a disconnect circuit configured to be coupled to a voltage source having a phase conductor and a neutral conductor, an output voltage connection coupled to the disconnect circuit; and a microprocessor circuit in communication with the disconnect circuit. The disconnect circuit is also configured to detect an overvoltage condition with respect to the phase conductor and the neutral conductor and to provide a first signal to the microprocessor circuit indicating whether the overvoltage condition is detected. The disconnect circuit is further configured to disconnect the phase conductor and the neutral conductor from the output voltage connection in response to a second signal from the microprocessor circuit if the overvoltage condition is detected, and to connect the phase conductor and the neutral conductor to the output voltage connection in response to the second signal if the overvoltage condition is not detected.

### CROSS-REFERENCE TO RELATED PATENT APPLICATIONS

This application claims the benefit of U.S. Provisional Application No. 60/641,627, filed Jan. 4, 2005 and entitled “Overvoltage Protection Device,” incorporated herein by reference in its entirety.

### BACKGROUND

The present description relates generally to overvoltage protection devices, and more specifically to overvoltage protection devices configured to protect electrical equipment from power supply voltage surges by automatically disconnecting and reconnecting the power supply.

Uninterruptible power supplies (UPSs) provide electrical power, such as from a back-up battery, to a connected load in the event of an interruption in the main incoming electrical power source. Voltage surges and overvoltage conditions are a common type of power source disturbance that can impact the performance of both the UPS and the connected load. Surge suppression devices, such as metal-oxide-varistors (MOVs) are commonly used to protect against voltage surges. However, prolonged exposure to voltage surges, or even brief exposures to large overvoltage conditions may damage both the UPS surge suppression circuitry or the connected load, as well as create fire or electrical hazards. Overvoltage protection devices which disconnect the incoming electrical power source during overvoltage conditions have been employed to protect against damage from overvoltage conditions. However, while disconnection of the incoming electrical power source during an overvoltage condition can reduce or even prevent damage, in order to be effective the disconnection device should be fast enough to reduce the amount of exposure to the overvoltage condition, should eliminate any possible paths for the overvoltage condition, and should provide a convenient way to restore power once the overvoltage condition is no longer present.

There is a need for an overvoltage protection device for use with a UPS or other device that provides improved protection for both the UPS or other device and any connected loads during a detected overvoltage condition. There is also need for an overvoltage protection device that provides a complete disconnect from a power source during a detected overvoltage condition, and automatically reconnects the power source once the overvoltage condition is no longer detected. There is also need for an overvoltage protection device that provides protection for internal surge suppressors and other internal circuitry during an overvoltage condition. There is also need for an overvoltage protection device that provides a quick response and reduces exposure to a detected overvoltage condition.

Accordingly, there is a need to provide an overvoltage protection device having any one or more of these or other advantageous features.

### SUMMARY

According to an exemplary embodiment, an overvoltage protection device includes a disconnect circuit configured to be coupled to a voltage source having a phase conductor and a neutral conductor, an output voltage connection coupled to the disconnect circuit; and a microprocessor circuit in communication with the disconnect circuit. The disconnect circuit is also configured to detect an overvoltage condition with respect to the phase conductor and the neutral conductor and to provide a first signal to the microprocessor circuit indicating whether the overvoltage condition is detected. The disconnect circuit is further configured to disconnect the phase conductor and the neutral conductor from the output voltage connection in response to a second signal from the microprocessor circuit if the overvoltage condition is detected, and to connect the phase conductor and the neutral conductor to the output voltage connection in response to the second signal if the overvoltage condition is not detected.

According to another exemplary embodiment, a method of providing overvoltage protection includes detecting whether an overvoltage condition is present with respect to a phase conductor and a neutral conductor of a voltage source coupled to a disconnect circuit of an overvoltage protection device, providing a first signal to a microprocessor circuit in communication with the disconnect device indicating whether the overvoltage condition is detected, disconnecting the phase conductor and the neutral conductor from an output voltage connection coupled to the disconnect circuit in response to a second signal from the microprocessor circuit if the overvoltage condition is detected, and connecting the phase conductor and the neutral conductor to the output voltage connection in response to the second signal if the overvoltage condition is not detected.

According to another exemplary embodiment, an overvoltage protection device includes means for detecting whether an overvoltage condition is present with respect to a phase conductor and a neutral conductor of a voltage source coupled to a disconnect circuit of an overvoltage protection device. The overvoltage protection device also includes means for providing a first signal to a microprocessor circuit in communication with the disconnect device indicating whether the overvoltage condition is detected. The overvoltage protection device also includes means for disconnecting the phase conductor and the neutral conductor from an output voltage connection coupled to the disconnect circuit in response to a second signal from the microprocessor circuit if the overvoltage condition is detected, and means for connecting the phase conductor and the neutral conductor to the output voltage connection in response to the second signal if the overvoltage condition is not detected.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### BRIEF DESCRIPTION OF THE DRAWINGS

The exemplary embodiments will hereafter be described with reference to the accompanying drawings, wherein like numerals depict like elements, and:

FIG. 1 is a diagram schematically illustrating an overvoltage protection device according to an exemplary embodiment;

FIG. 2 is a diagram schematically illustrating the disconnect circuit of FIG. 1 according to an exemplary embodiment;

FIG. 3 is an annotated wiring diagram schematically illustrating the overvoltage protection device of FIG. 1 in detail according to an exemplary embodiment;

FIG. 4 is a block diagram schematically illustrating an embodiment of the overvoltage protection device shown in FIG. 3; and

FIG. 5 is an annotated diagram schematically illustrating the disconnect circuit of FIG. 1 and FIG. 2 in detail according to an exemplary embodiment.

### DETAILED DESCRIPTION

In the following description, for the purposes of explanation, numerous details are set forth in order to provide a thorough understanding of the present invention. It will be evident to one skilled in the art, however, that the exemplary embodiments may be practiced without these specific details. In other instances, structures and device are shown in diagram form in order to facilitate description of the exemplary embodiments.

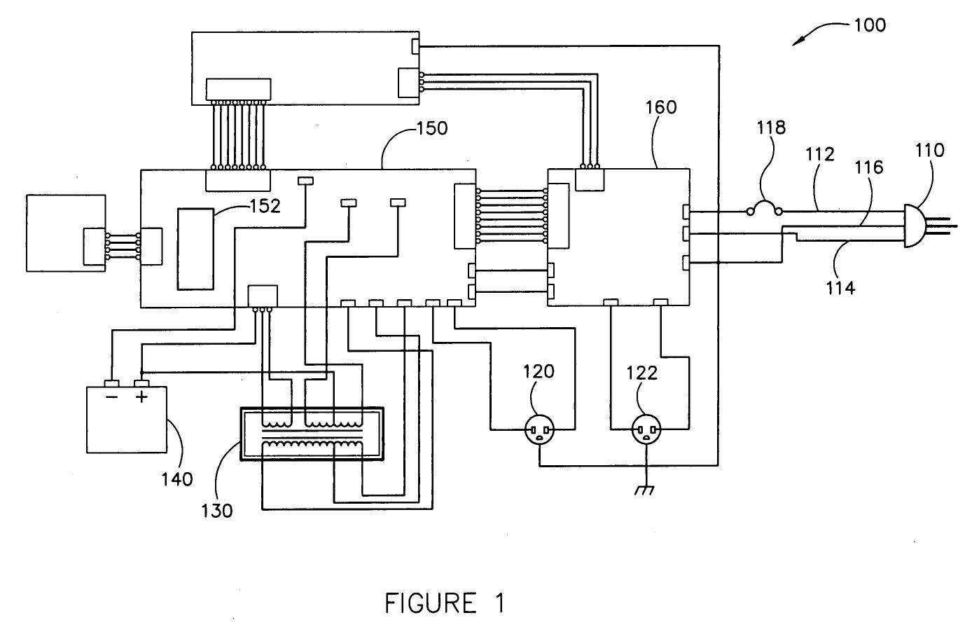

FIG. 1 is a diagram schematically illustrating an overvoltage protection device 100 according to an exemplary embodiment. Overvoltage protection device 100 may be incorporated as part of an uninterruptible power supply (UPS) as shown in FIG. 1, a surge suppressor, or other similar devices. As illustrated in FIG. 1, overvoltage protection device 100 includes a voltage source input 110, output voltage connections 120 and 122, a transformer 130, a battery 140, a microprocessor circuit 150, and a disconnect circuit 160. Overvoltage protection device 100 is generally configured to provide protection against damage from overvoltage conditions in commercial, industrial, or residential electrical systems. Such overvoltage conditions may be caused by, for example, wiring errors or crossed wires in an electrical system, an open-neutral utility fault in an electrical distribution system, etc. More specifically, overvoltage protection device 100 is intended to protect both itself and any electrical equipment connected to it from damage from overvoltage conditions by automatically disconnecting and reconnecting the voltage source.

Voltage source input 110 is configured to facilitate coupling of overvoltage protection device 100 to a voltage source (e.g., a removable plug, a “hard-wired” connection, etc.). For example, in the illustrated embodiment, voltage source input 110 is illustrated as a standard three-prong grounded plug for removably coupling overvoltage protection device 100 to an AC voltage source having a phase conductor 112, a neutral conductor 114, and a ground conductor 116. According to an exemplary embodiment, overvoltage protection device 100 is configured to be coupled to an AC voltage source having a rated voltage of 120 volts RMS at 60 Hertz. According to various other embodiments, voltage sources of other types may be used. A circuit breaker 118 may also be provided in line with phase conductor 112.

Output voltage connections 120 and 122 are configured to facilitate connection of a load to overvoltage protection device 100, such as a piece of electrical equipment powered by a voltage source to which overvoltage protection device 100 is coupled. For example, in the illustrated embodiment, output voltage connections 120 and 122 are illustrated as standard three-prong grounded outlets for removably coupling an AC load to overvoltage protection device 100. According to various other embodiments, output voltage connections of other types may be used.

Transformer 130 is configured to provide voltage regulation functions such that the voltage provided at output voltage connection 120 is maintained within a predetermined range around a nominal voltage. For example, according to an exemplary embodiment, transformer 130 is a 60 Hertz power transformer configured to regulate the voltage provided at output voltage connection 120 to within approximately 10% of a nominal AC output voltage of 120 volts RMS. According to various other embodiments, transformers of other types and ratings may be used. Battery 140 is configured to provide battery back-up power to a load connected to output voltage connection 120, as well as to microprocessor circuit 150 and other components within overvoltage protection device 100 in the event of an overvoltage condition.

Microprocessor circuit 150 includes microprocessor 152 and is coupled to output voltage connection 120, transformer 130, battery 140, and disconnect circuit 160. Microprocessor circuit 150 is configured to use conventional microprocessor control to control the overall operation of overvoltage protection device 100. For example, microprocessor circuit 150 is configured to respond to a detected overvoltage condition by automatically disconnecting and reconnecting the voltage source from overvoltage protection device 100 in response to the overvoltage condition, and to switch output voltage connection 120 to battery back-up power during an overvoltage condition. According to an exemplary embodiment, microprocessor circuit 150 is also configured to provide automatic voltage regulation of the voltage at output voltage connection 120 (e.g., using transformer 130, etc.).

Disconnect circuit 160 is coupled to voltage source input 110, output voltage connection 122, and microprocessor circuit 150. Disconnect circuit 160 is configured to detect an overvoltage condition at voltage source input 110, and to provide a signal to microprocessor circuit 150 indicating the overvoltage condition. Disconnect circuit 160 is also configured to respond to a signal from microprocessor circuit 150 by disconnecting or reconnecting the voltage source from overvoltage protection device 100 in response to an overvoltage condition.

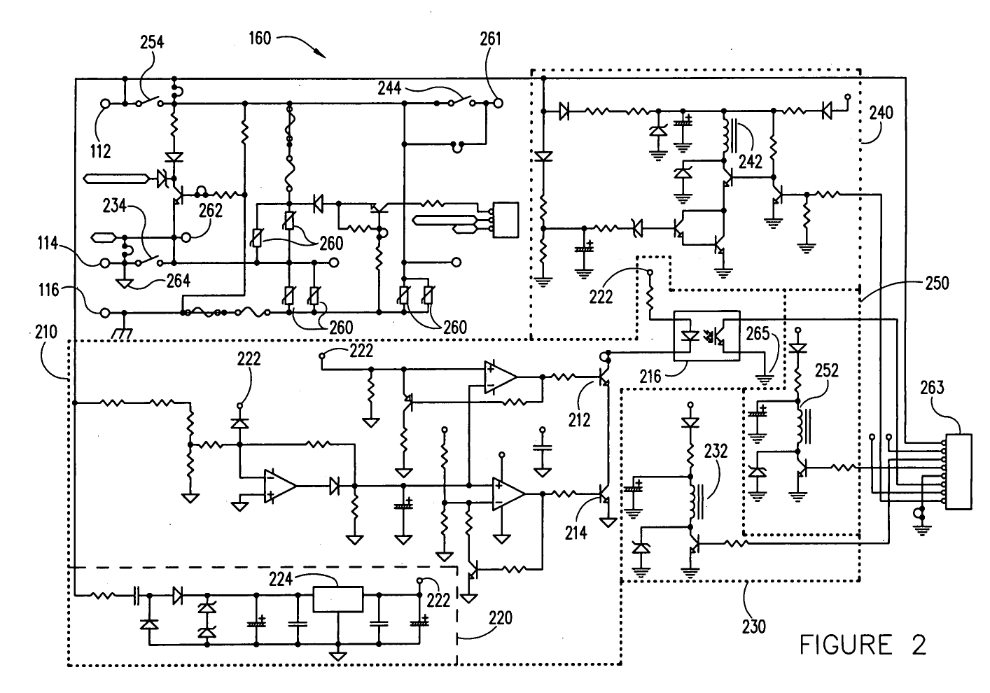

FIG. 2 is a diagram schematically illustrating disconnect circuit 160 according to an exemplary embodiment. In the illustrated embodiment, disconnect circuit 160 includes a voltage detection circuit 210, an auxiliary power circuit 220, a switch control circuit 230, a switch control circuit 240, a switch control circuit 250, and surge suppressors 260. Disconnect circuit 160 is coupled to phase conductor 112, neutral conductor 114, and ground conductor 116 as shown in FIG. 2. Disconnect circuit 160 is also coupled to output voltage connection 122 at nodes 261 and 262. Disconnect circuit 160 is coupled to microprocessor circuit 150 via a connector 263.

The connection between neutral conductor 114 and disconnect circuit 160 is coupled to a neutral reference 264 (indicated by an enclosed triangular symbol in FIG. 2), which is also used as a neutral reference for voltage detection circuit 210 and auxiliary power circuit 220. Disconnect circuit 160 also includes a secondary ground reference 265 (indicated by triangular symbol comprising horizontal lines in FIG. 2) that is electrically isolated from neutral reference 264. Secondary ground reference 265 is used as a ground reference for switch control circuit 230, switch control circuit 240, and switch control circuit 250, as well as for microprocessor circuit 150. Disconnect circuit 160 utilizes electrically isolated neutral reference 264 and secondary ground reference 265 in order to allow microprocessor circuit 150 to remain powered and to continue to respond to voltage detection circuit 210 during an overvoltage condition as will be described below.

Voltage detection circuit 210 is configured to monitor the voltage across phase conductor 112 and neutral conductor 114 (i.e., neutral reference 264) in order to detect the presence or absence of an overvoltage condition as a function of a predetermined voltage threshold. For example, according to an exemplary embodiment, voltage detection circuit 210 is configured to monitor a nominal AC voltage of 120 volts RMS across phase conductor 112 and neutral conductor 114 in order to detect an overvoltage of approximately 15 percent greater than the nominal voltage. Switches 212 and 214 in voltage detection circuit 210 respond to the voltage across phase conductor 112 and neutral conductor 114 by switching optical isolation switch 216 either ON or OFF based on the detected presence or absence of an overvoltage condition (i.e., a voltage greater than the predetermined threshold). Accordingly, optical coupler 216 provides a signal to microprocessor circuit 150 indicating the presence or absence of an overvoltage condition. Optical coupler 216 also maintains electrical isolation between voltage detection circuit 210 and microprocessor circuit 150 in order to allow microprocessor circuit 150 to remain powered and to continue to respond to voltage detection circuit 210 during an overvoltage condition.

Auxiliary power circuit 220 is configured to continuously provide power to voltage detection circuit 210 at node 222 (e.g., a DC voltage of approximately 12 volts) such that voltage detection circuit 210 may monitor the voltage across phase conductor 112 and neutral conductor 114. Auxiliary power circuit 220 includes a voltage regulator 224. Voltage regulator 224 may be any voltage regulator having an input voltage range suitable for continuous operation during both the presence and absence of an overvoltage condition.

Switch control circuit 230, switch control circuit 240, and switch control circuit 250 are configured to open or close a switched device in response to a signal from microprocessor circuit 150 such that phase conductor 112 and neutral conductor 114 may be disconnected from or reconnected to overvoltage protection device 100 in response to the presence or absence of an overvoltage condition. For example, in the illustrated embodiment, switch control circuit 230 includes a relay coil 232 configured to open or close a relay contact 234 in response to a signal from microprocessor circuit 150 such that neutral conductor 114 may be disconnected from or reconnected to overvoltage protection device 100 in response to the presence or absence of an overvoltage condition. Similarly, switch control circuit 240 and switch control circuit 250 include respective relay coils 242 and 252 configured to open or close respective relay contacts 244 and 254 in response to a signal from microprocessor circuit 150 such that phase conductor 112 may be disconnected from or reconnected to overvoltage protection device 100 in response to the presence or absence of an overvoltage condition.

Surge suppressors 260 are configured to provide protection from transient voltage surges at voltage source input 110. Surge suppressors 260 may be any suitable type of surge suppressor component. According to an exemplary embodiment, surge suppressors 260 are metal-oxide-varistors (MOVs). Surge suppressors 260 are positioned between voltage source input 110 and output voltage connections 120 and 122 in order to provide protection from transient voltage surges at voltage source input 110. Surge suppressors 260 are also separated from voltage source input 110 by switches controlled by switch control circuit 230, switch control circuit 240, and switch control circuit 250. For example, as shown in FIG. 2, surge suppressors 260 are located within disconnect circuit 160 such that they are separated from phase conductor 112 and neutral conductor 114 by relay contacts 234, 244, and 254 respectively controlled by switch control circuit 230, switch control circuit 240, and switch control circuit 250. Accordingly, surge suppressors 260 are protected from damage from an overvoltage condition when the switches controlled by switch control circuit 230, switch control circuit 240, and switch control circuit 250 are opened in response to a signal from microprocessor circuit 150 such that phase conductor 112 and neutral conductor 114 are disconnected.

The operation of overvoltage protection device 100 will now be described with reference to FIG. 1 and FIG. 2. Voltage detection circuit 210 is powered by auxiliary power circuit 220 and monitors the voltage across phase conductor 112 and neutral conductor 114 in order to detect the presence or absence of an overvoltage condition as a function of a predetermined voltage threshold. Switches 212 and 214 in voltage detection circuit 210 respond to the voltage across phase conductor 112 and neutral conductor 114 by switching optical isolation switch 216 either ON or OFF based on the detected presence or absence of an overvoltage condition (i.e., a voltage greater than the predetermined threshold). Optical isolation switch 216 provides a signal to microprocessor circuit 150 indicating the presence or absence of an overvoltage condition. When no overvoltage condition is detected, microprocessor circuit 150 provides signals to switch control circuit 230, switch control circuit 240, and switch control circuit 250 so that their respective switches remain closed. Phase conductor 112 and neutral conductor 114 are connected to disconnect circuit 160 via these switches so that power from voltage source input 110 is provided at output voltage connection 120.

When the voltage across phase conductor 112 and neutral conductor 114 crosses the predetermined threshold, switches 212 and 214 in voltage detection circuit 210 respond by switching optical isolation switch 216 such that optical isolation switch 216 provides a signal to microprocessor circuit 150 indicating the presence of the overvoltage condition. In response to the detected overvoltage condition, microprocessor circuit 150 provides signals to switch control circuit 230, switch control circuit 240, and switch control circuit 250 so that their respective switches are opened. Phase conductor 112 and neutral conductor 114 are disconnected from disconnect circuit 160 via these switches so that power from voltage source input 110 is no longer provided at output voltage connections 120 and 122. Instead, microprocessor circuit 150 causes power from battery 140 to be provided at output voltage connections 120 and 122. According to an exemplary embodiment, overvoltage protection device 100 is configured to respond to a detected overvoltage condition by opening the switches controlled by switch control circuit 230, switch control circuit 240, and switch control circuit 250 within approximately one half of an AC voltage cycle once the overvoltage condition is detected. According to another exemplary embodiment, the overvoltage protection device may be configured to respond at another speed suited for use with the intended loads.

During the detected overvoltage condition, phase conductor 112 remains connected to voltage detection circuit 210 and auxiliary power circuit 220 such that auxiliary power circuit 220 may continue to provide power to voltage detection circuit 210, and so that voltage detection circuit 210 may continue to monitor the voltage across phase conductor 112 and neutral conductor 114. Battery power is used to power microprocessor circuit 150. Electrically isolated neutral reference 264 and secondary ground reference 265 allow microprocessor circuit 150 to remain powered and to continue to respond to voltage detection circuit 210 during the overvoltage condition. Optical coupler 216 also maintains electrical isolation between voltage detection circuit 210 and microprocessor circuit 150 while providing the signal indicating the presence of the overvoltage condition in order to allow microprocessor circuit 150 to remain powered and to continue to respond to voltage detection circuit 210 during the overvoltage condition.

When the overvoltage condition is no longer detected by voltage detection circuit 210, overvoltage protection device 100 is automatically reset to provide power from voltage source input 110 at output voltage connections 120 and 122. Optical isolation switch 216 provides a signal to microprocessor circuit 150 indicating that the overvoltage condition is no longer present. In response, microprocessor circuit 150 provides signals to switch control circuit 230, switch control circuit 240, and switch control circuit 250 so that their respective switches are closed. Phase conductor 112 and neutral conductor 114 are reconnected to disconnect circuit 160 via these switches so that power from voltage source input 110 is again provided at output voltage connections 120 and 122.

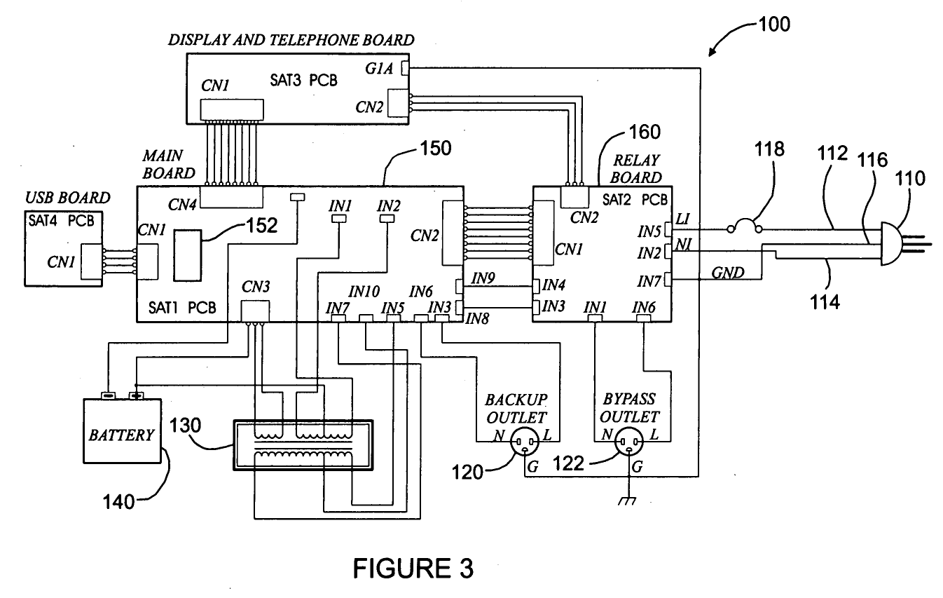

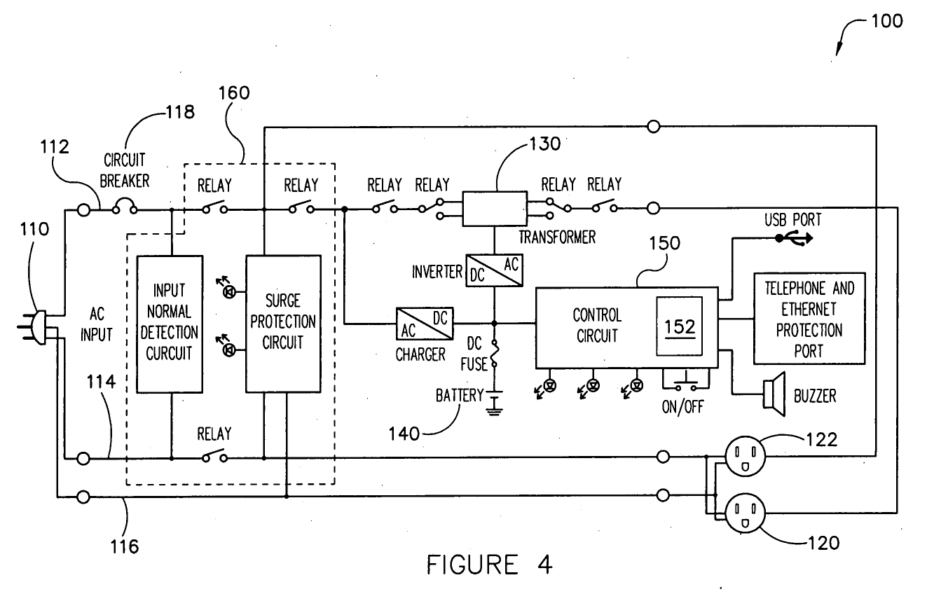

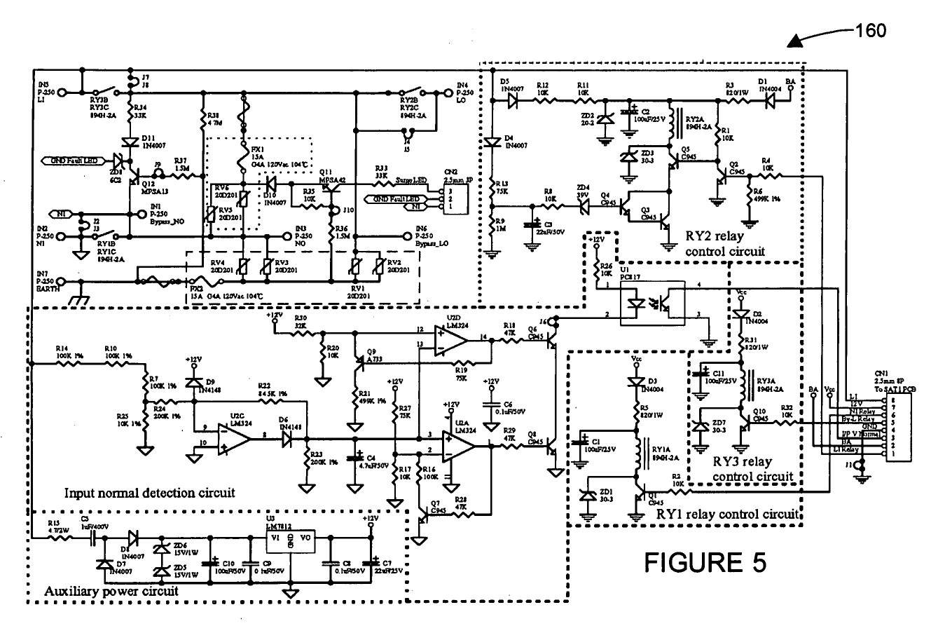

FIG. 3 is an annotated wiring diagram schematically illustrating overvoltage protection device 100 in detail according to an exemplary embodiment. FIG. 4 is a block diagram schematically illustrating an embodiment of overvoltage protection device 100 shown in FIG. 3 in a more simplified manner. The embodiment of the overvoltage protection device shown in FIGS. 3 and 4 is generally configured to implement the operation of overvoltage protection device 100 as described above with reference to FIG. 1 and FIG. 2. The microprocessor circuit 150 shown in FIGS. 3 and 4 implements microprocessor control techniques of a conventional type and is preferably configured to respond to a detected overvoltage condition within approximately one half of an AC voltage cycle once the overvoltage condition is detected. FIG. 5 is an annotated diagram, including exemplary component values, that schematically illustrates disconnect circuit 160 in detail according to an exemplary embodiment.

The overvoltage protection device as described herein thus provides improved protection for both itself and any connected loads during a detected overvoltage condition. The overvoltage protection device provides a complete disconnect by disconnecting both the phase and neutral conductors during the detected overvoltage condition, which prevents voltage surges from routing over the neutral and ground conductors. The optical coupler circuit in the overvoltage protection device allows the microprocessor circuit to remain electrically isolated during the overvoltage condition such that it may continue to monitor the input voltage of the voltage source and automatically reconnect the phase and neutral conductors once the overvoltage condition is no longer detected. The surge suppressors in the overvoltage protection device are also protected during an overvoltage condition, which may reduce or prevent damage to the overvoltage protection device, as well as reduce or prevent electrical fire hazards. The overvoltage device may also provide a quicker response and reduce exposure to a detected overvoltage condition by disconnecting both the phase and neutral conductors within approximately one half of an AC voltage cycle once the overvoltage condition is detected.

It is important to note that the construction and arrangement of the elements of the overvoltage protection device as shown in the exemplary embodiments is illustrative only. Although only a few embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present invention.

1. An overvoltage protection device, comprising:
a disconnect circuit configured to be coupled to a voltage source having a phase conductor and a neutral conductor;
an output voltage connection coupled to the disconnect circuit; and
a microprocessor circuit in communication with the disconnect circuit;
wherein the disconnect circuit is also configured to detect an overvoltage condition with respect to the phase conductor and the neutral conductor and to provide a first signal to the microprocessor circuit indicating whether the overvoltage condition is detected, and wherein the disconnect circuit is further configured to disconnect the phase conductor and the neutral conductor from the output voltage connection in response to a second signal from the microprocessor circuit if the overvoltage condition is detected, and to connect the phase conductor and the neutral conductor to the output voltage connection in response to the second signal if the overvoltage condition is not detected.

2. The overvoltage protection device of claim 1, wherein the overvoltage protection device is further configured to disconnect the phase conductor and the neutral conductor from the output voltage connection within approximately one-half of an AC voltage cycle of the voltage source upon detection of the overvoltage condition.

3. The overvoltage protection device of claim 1, wherein the disconnect circuit further comprises surge suppression devices.

4. The overvoltage protection device of claim 3, wherein the disconnect circuit is further configured to disconnect the surge suppression devices from the phase conductor and the neutral conductor in response to the second signal from the microprocessor circuit if the overvoltage condition is detected, and to connect the surge suppression devices to phase conductor and the neutral conductor in response to the second signal if the overvoltage condition is not detected.

5. The overvoltage protection device of claim 3, wherein the surge suppression devices are metal oxide varistors.

6. The overvoltage protection device of claim 1, further comprising an optical coupler configured to provide electrical isolation between a voltage detection circuit and the microprocessor circuit.

7. The overvoltage protection device of claim 1, wherein the overvoltage protection device is an uninterruptible power supply.

8. A method of providing overvoltage protection, comprising:
detecting whether an overvoltage condition is present with respect to a phase conductor and a neutral conductor of a voltage source coupled to a disconnect circuit of an overvoltage protection device;
providing a first signal to a microprocessor circuit in communication with the disconnect device indicating whether the overvoltage condition is detected;
disconnecting the phase conductor and the neutral conductor from an output voltage connection coupled to the disconnect circuit in response to a second signal from the microprocessor circuit if the overvoltage condition is detected; and
connecting the phase conductor and the neutral conductor to the output voltage connection in response to the second signal if the overvoltage condition is not detected.

9. The method of claim 8, wherein disconnecting the phase conductor and the neutral conductor from the output voltage connection comprises disconnecting the phase conductor and the neutral conductor from the output voltage connection within approximately one-half of an AC voltage cycle upon detection of the overvoltage condition.

10. The method of claim 8, wherein the disconnect circuit further comprises surge suppression devices.

11. The method of claim 10, further comprising disconnecting the surge suppression devices from the phase conductor and the neutral conductor in response to the second signal from the microprocessor circuit if the overvoltage condition is detected; and
connecting the surge suppression devices to phase conductor and the neutral conductor in response to the second signal if the overvoltage condition is not detected.

12. The method of claim 10, wherein the surge suppression devices are metal oxide varistors.

13. The method of claim 8, further comprising providing electrical isolation between the microprocessor circuit and a voltage detection circuit using an optical isolator.

14. The method of claim 8, wherein the overvoltage protection device is an uninterruptible power supply.

15. An overvoltage protection device, comprising:
means for detecting whether an overvoltage condition is present with respect to a phase conductor and a neutral conductor of a voltage source coupled to a disconnect circuit of an overvoltage protection device;
means for providing a first signal to a microprocessor circuit in communication with the disconnect device indicating whether the overvoltage condition is detected;
means for disconnecting the phase conductor and the neutral conductor from an output voltage connection coupled to the disconnect circuit in response to a second signal from the microprocessor circuit if the overvoltage condition is detected; and
means for connecting the phase conductor and the neutral conductor to the output voltage connection in response to the second signal if the overvoltage condition is not detected.

16. The overvoltage protection device of claim 15, wherein the means for disconnecting the phase conductor and the neutral conductor from the output voltage connection is configured to disconnect the phase conductor and the neutral conductor from the output voltage connection within approximately one-half of an AC voltage cycle upon detection of the overvoltage condition.

17. The overvoltage protection device of claim 15, wherein the disconnect circuit includes surge suppression devices.

18. The overvoltage protection device of claim 17, wherein the means for disconnecting the phase conductor and the neutral conductor is configured to disconnect the surge suppression devices from the phase conductor and the neutral conductor in response to the second signal from the microprocessor circuit if the overvoltage condition is detected; and
wherein the means for disconnecting the phase conductor and the neutral conductor is further configured to connect the surge suppression devices to phase conductor and the neutral conductor in response to the second signal if the overvoltage condition is not detected.

19. The overvoltage protection device of claim 17, wherein the surge suppression devices are metal oxide varistors.

20. The overvoltage protection device of claim 15, further comprising means for providing electrical isolation between a voltage detection circuit and the microprocessor circuit.

21. The overvoltage protection device of claim 15, wherein the overvoltage protection device is an uninterruptible power supply.
